(19) United States
(12) Patent Application Publication
(10) Pub. No.: US 2006/0217516 A1
(43) Pub. Date: Sep. 28, 2006

(54) Tertiary amine modified polyurethane products made therefrom

(76) Inventors: Francois M. Casati, Prevessin-Moens (FR); Joseph Gan, Strasbourgh (FR); Richard M. Wehmeyer, Lake Jackson, TX (US); Robert H. Whitmarsh, Elkview, WV (US); Ray E. Drumright, Midland, MI (US); John W. Weston, Sugar Land, TX (US)

Correspondence Address: THE DOW CHEMICAL COMPANY, INTELLECTUAL PROPERTY SECTION,, P. O. BOX 1967, MIDLAND, MI, 48641-1967, US

(21) Appl. No.: 10/497,352

(22) PCT Filed: Dec. 17, 2002
(86) PCT No.: PCT/US02/40456

§ 371 Date: Jan. 18, 2005

Related U.S. Application Data
(60) Provisional application No. 60/345,294, filed on Dec. 21, 2001.

(51) Int. Cl. C08G 18/00

(52) U.S. Cl. 528/44

(57) ABSTRACT

The present invention pertains to low emission polyurethane polymer products based on autocatalytic polyols made by modification of conventional polyols with tertiary amines and processes for their manufacture. The tertiary amine is bound to a conventional polyol by means of an epoxide, epichlorohydrin, or grafting by means of an azo and/or peroxide initiator or sulfonyl azide.

The present invention pertains to low emission polyurethane polymer products based on autocatalytic polyols made by modification of conventional polyols with tertiary amines and processes for their manufacture.

Polyether polyols based on the polymerization of alkylene oxides, and/or polyester polyols, are the major components of a polyurethane system together with isocyanates. These systems generally contain additional components such as cross-linkers, chain extenders, surfactants, cell regulators, stabilizers, antioxidants, flame retardant additives, eventually fillers, and typically catalysts such as tertiary amines and/or organometallic salts.

Organometallic catalysts, such as lead or mercury salts, can raise environmental issues due to leaching upon aging of the polyurethane products. Others, such as tin salts, are often detrimental to polyurethane aging.

The commonly used tertiary amine catalysts, cause several problems, particularly in flexible, semi-rigid and rigid foam applications. Freshly prepared foams using these catalysts often exhibit the typical odor of the amines and give rise to increased fogging (emission of volatile products).

The presence, or formation, of even traces of tertiary amine catalyst vapors in polyurethane products having vinyl films or polycarbonate sheets exposed thereto can be disadvantageous. Such products commonly appear in automotive interiors as seats, armrests, dashboards or instrument panels, sun visors, door linings, noise insulation parts either under the carpet or in other parts of the car interior or in the engine compartment, as well as in many domestic applications such as shoe soles, cloth interliners, appliance, furniture and bedding. While these materials perform excellently in these applications, they possess a deficiency that has been widely recognized. Specifically, the tertiary amine catalysts present in polyurethane foams have been linked to the staining of the vinyl film and degradation of polycarbonate sheets. This PVC staining and polycarbonate decomposition problems are especially prevalent in environments wherein elevated temperatures exist for long periods of time, such as in automobile interiors, which favor emission of amine vapors.

Various solutions to this problem have been proposed. One is the use of amine catalysts which contain an isocyanate reactive group, that is a hydroxyl or a primary and/or a secondary amine. Such a compound is disclosed in EP 747,407. Other types of reactive monol catalysts are described in U.S. Pat. Nos. 4,122,038, 4,368,278 and 4,510,269. A reported advantage of the catalyst compositions is that they are incorporated into the polyurethane product. However those catalysts have to be used at high levels in the polyurethane formulation to compensate for their reduced effectiveness. Since they are usually monofunctional, these reactive amines act as chain stoppers and have a detrimental effect on the polymer network formation and affect polyurethane product physical characteristics.

Use of specific amine-initiated polyols is proposed in EP 539,819, in U.S. Pat. No. 5,672,636 and in WO 01/58,976. However such processes give rise to potential cross-contamination issues with conventional polyols in manufacturing plants since both polyol types are produced in the same reactors.

Modification of conventional polyols by partial amination has been disclosed in U.S. Pat. No. 3,838,076. While this gives additional reactivity to the polyol, this does not allow adjustment of processing conditions since these aminated functions are rapidly tied in the polymer by reacting with the isocyanate.

Pre-polymerization of reactive amine catalysts with a polyisocyanate and a polyol is reported in PCT WO 94/02525. These isocyanate-modified amines show comparable or enhanced catalytic activity compared with the corresponding non-modified amine catalysts. However, this process gives handling difficulties such as gel formation and poor storage stability.

Modifications of polyether polyols with epoxy resin-diamine or epoxy resin-amino-alcohol adducts are described in U.S. Pat. No. 4,518,720, in U.S. Pat. No. 4,535,133 and in U.S. Pat. No. 4,609,685 respectively. However these modifications are designed to improve foam properties. No mention is made of getting an autocatalytic effect or a reduction of catalysts when using these modified polyols. The same comment can be made of U.S. Pat. No. 4,647,624 which is about epoxy-modified polyols.

Addition to a polyurethane-forming mixture of a stabilizer based on polyepoxides containing at least one tertiary nitrogen is claimed in U.S. Pat. No. 4,775,558. Objective of the invention is to improve thermal stability and not of reducing the level of catalysts in the system.

Polyol modification with tertiary amines are disclosed in U.S. Pat. No. 5,482,979 using aminocrotonic acid esters containing tertiary amino groups and in EP 696,580 with tertiary amines exhibiting carbonate and urethane groups but while these processes give polyols with autocatalytic activity, these have a reduced functionality since several of their hydroxyl groups have been reacted. By consequence their use is either limited in concentration in the polyurethane formulation or it affects negatively final product physical properties.

Capping of conventional polyether polyols with N,N-dialkylglycidylamine is claimed in U.S. Pat. No. 3,428,708. While this process gives polyols with autocatalytic activity, it is restricted to dialkylamino groups which are mainly active to catalyze the water-isocyanate reaction and much less the polyol-isocyanate reaction.

Therefore, there continues to be a need for alternative means to control vinyl staining and polycarbonate decomposition by polyurethane compositions.

There also remains a need to eliminate or reduce the amount of amine catalysts and/or organometallic salts in producing polyurethane products.

There is also a need to have an industrial process to manufacture autocatalytic polyether polyols without interfering with conventional polyol production and polyurethane product processes and characteristics.

It is an object of the present invention to produce polyurethane products containing a reduced level of conventional tertiary amine catalysts, a reduced level of reactive amine catalysts or polyurethane products produced without the need of such amine catalysts. It is an another objective of the present invention to produce polyurethane products containing a reduced level of organometallic catalyst or to produce such products in the absence of organometallic catalysts. With the reduction of the amount of amine and/or organometallic catalysts needed or elimination of such catalysts, the disadvantages associated with such catalysts as given above can be minimized or avoided.

It is another object of the invention to have a process to modify a conventional polyol with any tertiary amine to make it autocatalytic without reducing its functionality.

It is a further object of the present invention to provide autocatalytic polyols made from tertiary amine modification of conventional polyols so that the industrial manufacturing process of the polyurethane product using these autocatalytic polyols and the physical characteristics of the polyurethane products made therefrom are not adversely affected and may even be improved by the reduction in the amount of conventional or reactive amine catalysts or in elimination of the amine catalyst, and/or by reduction or elimination of organometallic catalysts.

In another aspect, the use of the autocatalytic polyols of the present invention could reduce the level of amine catalysts to which workers would be exposed in the atmosphere in a manufacturing plant.

The present invention is a process for the production of a polyurethane product by reaction of a mixture of

(a) at least one organic polyisocyanate with

(b) a polyol composition comprising

(b1) from 0 to 99 percent by weight of a polyol compound having a functionality of 2 to 8 and a hydroxyl number of from 20 to 800 and (b2) from 1 to 100 percent by weight of at least one polyol compound having a functionality of 1 to 12, a hydroxyl number of from 20 to 800 and containing at least one tertiary amine group,

wherein the weight percent is based on the total amount of polyol composition (b), (b1) is different than (b2) and (b2) is one or more of:

polyol (b2a) obtained by the reactions of a polyol of (b1) type with a polyepoxide and an amine based molecule wherein the amine base molecule is a secondary amine or a molecule containing at least one tertiary nitrogen and at least one reactive hydrogen able to react with the epoxide group;

polyol (b2b) obtained by the reactions of a polyol of (b1) type with an epihalohydrin and an amine based molecule wherein the amine based molecule is a secondary amine or a molecule containing at least one tertiary nitrogen and at least one reactive hydrogen able to react with the product of the polyol (b1) an epihalohydrin group;

or polyol (b2c) obtained by reaction of a polyol made from epihalohydrin as a co-monomer together with propylene oxide and/or ethylene oxide and an amine based molecule wherein the amine based molecule is a secondary amine or a molecule containing at least one tertiary nitrogen and at least one reactive hydrogen able to react with a haloalkyl;

or polyol (b2d) obtained by grafting of tertiary amine functions to a polyol of (b1) by functional azo and/or peroxide initiator;

or polyol (b2e) obtained by grafting of tertiary amine functions onto a polyol of (b1) via a reactive functionality such as sulfonyl azide;

or (b2) is (b2f) a hydroxyl-tipped prepolymer obtained from the reaction of an excess of (b2a)-(b2e) or a mixture thereof with a polyisocyanate;

or (b2) is (b2g) a blend of several polyols (b2) or a blend of (b2a) and/or (b2b) and/or (b2c) and/or (b2d) and/or (b2e);

(c) optionally in the presence of a blowing agent; and

(d) optionally additives or auxiliary agents known per se for the production of polyurethane foams, elastomers and/or coatings.

In another embodiment, the present invention is a process as disclosed above wherein polyol (b1) is a blend which contains at least one amine initiated polyol (b3).

In another embodiment, the present invention is a process as disclosed above wherein the polyisocyanate (a) contains at least one polyisocyanate that is a reaction product of a excess of polyisocyanate with a polyol as defined by (b2).

In a further embodiment, the present invention is a process as disclosed above where the polyol (b) contains a polyol-terminated prepolymer obtained by the reaction of an excess of polyol with a polyisocyanate wherein the polyol is a polyol as defined by (b2).

In still another embodiment, the present invention is an isocyanate-terminated prepolymer based on the reaction of a polyol as defined by (b2) with an excess of a polyisocyanate.

In yet another embodiment, the present invention is a polyol-terminated prepolymer based on the reaction of a polyisocyanate with an excess of polyol as defined by (b2).

The invention further provides for polyurethane products produced by any of the above processes.

The polyols containing bonded tertiary amine functions as disclosed in the present invention are catalytically active and accelerate the addition reaction of organic polyisocyanates with polyhydroxyl or polyamino compounds and the reaction between the isocyanate and the blowing agent such as water or a carboxylic acid or its salts. The addition of these polyols to a polyurethane reaction mixture reduces or eliminates the need to include a conventional tertiary amine catalyst within the mixture or an organometallic catalyst. Their addition to polyurethane reaction mixtures can also reduce the mold dwell time in the production of molded foams or improve some polyurethane product properties.

In accordance with the present invention, a process for the production of polyurethane products is provided, whereby polyurethane products of relatively low odor and low emission of amine catalyst are produced. Furthermore, the polyurethane products produced in accordance with the invention exhibit a reduced tendency to stain vinyl films or to degrade polycarbonate sheets with which they are exposed, display excellent adhesion properties (in appropriate formulations), have a reduced tendency to produce ‘blue haze’ which is associated with the use of certain tertiary amine catalysts, are more environmental friendly through the reduction/elimination of organometallic catalysts. These advantages are achieved by including in the reaction mixture either a polyol (b2) modified with a tertiary amine, or by including such polyols (b2) as feedstock in the preparation of SAN (styrene-acrylonitrile), PIPA (polyisocyanate polyaddition) or PHD (polyurea or polyharnstoff) copolymer polyols and adding them to the reaction mixture or by using such polyols in a prepolymer with a polyisocyanate alone or with an isocyanate and a second polyol.

The combination of polyols used in the present invention will be a combination of (b1) and (b2) as described above and eventually with addition of polyol (b3) made from an amine initiation, such as, for instance those described in WO 01/58,976 and U.S. Pat. Nos. 5,476,969 and 5,672,636. As used herein the term polyols are those materials having at least one group containing an active hydrogen atom capable of undergoing reaction with an isocyanate. Preferred among such compounds are materials having at least two hydroxyls, primary or secondary, or at least two amines, primary or secondary, carboxylic acid, or thiol groups per molecule. Compounds having at least two hydroxyl groups or at least two amine groups per molecule are especially preferred due to their desirable reactivity with polyisocyanates.

Suitable polyols (b1) that can be used to produce polyurethane materials with the autocatalytic polyols (b2) of the present invention are well known in the art and include those described herein and any other commercially available polyol and/or SAN, PIPA or PHD copolymer polyols. Such polyols are described in “Polyurethane Handbook”, by G. Oertel, Hanser publishers. Mixtures of one or more polyols and/or one or more copolymer polyols may also be used to produce polyurethane products according to the present invention.

Representative polyols include polyether polyols, polyester polyols, polyhydroxy-terminated acetal resins, hydroxyl-terminated amines and polyamines. Examples of these and other suitable isocyanate-reactive materials are described more fully in U.S. Pat. No. 4,394,491. Alternative polyols that may be used include polyalkylene carbonate-based polyols and polyphosphate-based polyols. Preferred are polyols prepared by adding an alkylene oxide, such as ethylene oxide, propylene oxide, butylene oxide or a combination thereof, to an initiator having from 2 to 8, preferably 2 to 6 active hydrogen atoms. Catalysis for this polymerization can be either anionic or cationic, with catalysts such as KOH, CsOH, boron trifluoride, or a double cyanide complex (DMC) catalyst such as zinc hexacyanocobaltate or quaternary phosphazenium compound.

The polyol or blends thereof employed depends upon the end use of the polyurethane product to be produced. The molecular weight or hydroxyl number of the base polyol may thus be selected so as to result in flexible, semi-flexible, integral-skin or rigid foams, elastomers or coatings, or adhesives when the polymer/polyol produced from the base polyol is converted to a polyurethane product by reaction with an isocyanate, and depending on the end product in the presence of a blowing agent. The hydroxyl number and molecular weight of the polyol or polyols employed can vary accordingly over a wide range. In general, the hydroxyl number of the polyols employed may range from 20 to 800.

In the production of a flexible polyurethane foam, the polyol is preferably a polyether polyol and/or a polyester polyol. The polyol generally has an average functionality ranging from 2 to 5, preferably 2 to 4, and an average hydroxyl number ranging from 20 to 100 mg KOH/g, preferably from 20 to 70 mgKOH/g. As a further refinement, the specific foam application will likewise influence the choice of base polyol. As an example, for molded foam, the hydroxyl number of the base polyol may be on the order of 20 to 60 with ethylene oxide (EO) capping, and for slabstock foams the hydroxyl number may be on the order of 25 to 75 and is either mixed feed EO/PO (propylene oxide) or is only slightly capped with EO or is 100 percent PO based. For elastomer applications, it will generally be desirable to utilize relatively high molecular weight base polyols, from 2,000 to 8,000, having relatively low hydroxyl numbers, for example, 20 to 50.

Typically polyols suitable for preparing rigid polyurethanes include those having an average molecular weight of 100 to 10,000 and preferably 200 to 7,000. Such polyols also advantageously have an average functionality of at least 2, preferably 3, and up to 8, preferably up to 6, active hydrogen atoms per molecule. The polyols used for rigid foams generally have a hydroxyl number of 200 to 1,200 and more preferably from 300 to 800.

For the production of semi-rigid foams, it is preferred to use a trifunctional polyol with a hydroxyl number of 30 to 80.

The initiators for the production of polyols (b1) generally have 2 to δ functional groups that will react with the alkylene oxide. Examples of suitable initiator molecules are water, organic dicarboxylic acids, such as succinic acid, adipic acid, phthalic acid and terephthalic acid and polyhydric, in particular dihydric to octahydric alcohols or dialkylene glycols, for example ethanediol, 1,2- and 1,3-propanediol, diethylene glycol, dipropylene glycol, 1,4-butanediol, 1,6-hexanediol, glycerol, trimethylolpropane, pentaerythritol, sorbitol and sucrose or blends thereof. Other initiators include compounds linear and cyclic amine compounds containing eventually a tertiary amine such as ethanoldiamine, triethanoldiamine, and various isomers of toluene diamine.

The polyepoxides, or epoxy resins, for producing the catalytic polyols of (b2a) are known in the art. See for example, U.S. Pat. Nos. 4,066,628 and 4,609,685 the disclosures of which are incorporated herein by reference. The polyepoxide materials can be saturated or unsaturated, aliphatic, cycloaliphatic, aromatic or heterocyclic and may be substituted if desired with other substituents besides the epoxy groups, for example, hydroxyl, groups, ether radicals and aromatic halogen atoms. Preferred polyepoxides are aliphatic or cycloaliphatic polyepoxides, more preferably diepoxides.

Particularly useful polyepoxide compounds which can be used in the practice of the present invention are polyepoxides having the following general formula: 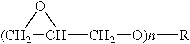
wherein R is substituted or unsubstituted aromatic, alphatic, cycloaliphatic or heterocyclic polyvalent group and n had an average value of from 2 to less than 8.

Examples of common epoxy resins include for example, the diglycidyl ethers of resorcinol, catechol, hydroquinone, bisphenol, bisphenol A, bisphenol AP (1,1-bis(4-hydroxylphenyl)-1-phenyl ethane), bisphenol F, bisphenol K, tetrabromobisphenol A, phenol-formaldehyde novolac resins, alkyl substituted phenol-formaldehyde resins, phenol-hydroxybenzaldehyde resins, cresol-hydroxybenzaldehyde resins, dicyclopentadiene-phenol resins, trimethylolpropane triglycidyl ether, dicyclopentadiene-substituted phenol resins tetramethylbiphenol, tetramethyl-tetrabromobiphenol, tetramethyltribromobiphenol, tetrachlorobisphenol A and any combination thereof.

Examples of preferred diepoxides are hydrogenated liquid aromatic epoxy resins of bis-phenol A or bisphenol F; and diepoxides D.E.R. 736, D.E.R. 732 (aliphatic epoxides) and ERL-4221 (cyclic aliphatic epoxide) available from The Dow Chemical Company. A mixture of any two or more polyexpoxides can be used in the practice of the present invention. Preferably the epoxide resin has an average equivalent weight of 90 to 500. More preferably the epoxy resin has an average equivalent weight of 150 to 400.

The amine compounds for producing the autocatalytic polyols of (b2) are those which react with an epoxide moiety or with a chlorohydrin group to produce a tertiary amine. Such compounds include secondary amines and/or molecules which contain a tertiary amine and at least one reactive hydrogen able to react with an epoxide. The polyepoxide acts as a bridging group between the polyol and the tertiary amine based molecule. Groups reactive with epoxides include primary or secondary, aliphatic or aromatic amines; primary, secondary and/or tertiary alcohols; amides; ureas; and urethanes.

Generally, secondary amines can be represented by HNR₂¹ where each R¹ is independently a moiety having 1 to 20 carbon atoms, such as a linear or branched alkyl or alkylaryl, or may be attached together with the nitrogen atom and optionally other hetero atoms and alkyl-substituted hetero atoms to form one or two saturated heterocyclic or an aromatic ring(s).

Compounds containing at least one tertiary nitrogen and at least one hydrogen atom reactive to an epoxide can be represented by
(R³)ₓ-A-(R²-M)_{z}-(R²)_{y}
where A is either hydrogen, nitrogen or oxygen;
x is 0, 1 or 2;
z is 1 or 2
with the provisos x is zero when A is hydrogen, x and z are 1 when A is oxygen, and when A is nitrogen x and z can be 1 or 2 with the sum of x and z being 3;
R² at each occurrence is independently a moiety having 1 to 20 carbon atoms;
R³ is hydrogen or a moiety having 1 to 20 carbon atoms;
M is an amine or polyamine, linear, branched or cyclic, with at least one tertiary amine group; and
y is an integer from 0 to 6. Preferably M has a molecular weight of 30 to 300. More preferably M has a molecular weight of 50 to 200.

Examples of amines that are commercially available and that can be used to manufacture polyols of (b2), specifically (b2a), (b2b), (b2c), are dimethylamine, diethylamine, N,N-dimethylethanolamine, N,N-dimethyl-N′-ethylenediamine, 3-dimethylamino-1-propanol, 1-dimethylamino-2-propanol, 3-(dimethylamino) propylamine, dicyclohexylamine, 1-(3-aminopropyl)-imidazole, 3-hydroxymethyl quinuclidine, imidazole, 2-methyl imidazole, 1-(2-aminoethyl)-piperazine, 1-methyl-piperazine, 3-quinuclidinol, tetramethylamino-bis-propylamine, 2-(2-aminoethoxy)-ethanol, N,N-dimethylaminoethyl-N′-methyl ethanolamine and 2-(methylamino)-ethanol. Other types of amines which can be used with the present invention are N,N′-dimethylethylenediamine, 4,6-dihydroxypyrimidine, 2,4-diamino-6-hydroxypyrimidine, 2,4-diamino-6-methyl-1,3,5-triazine, 3-aminopyridine, 2,4-diaminopyrimidine, 2-phenyl-imino-3-(2-hydroxyethyl)-oxazalodine,N-(-2-hydroxyethyl)-2-methyl-tetrahydropyrimidine, N-(2-hydroxyethyl)-imidazoline,2,4-bis-(N-methyl-2-hydroxytethylamino)-6-phenyl-1,3,5-triazine, bis-(dimethylaminopropyl)amino-2-propanol, 2-(2-methylaminoethyl)-pyridine, 2-(methylamino)-pyridine, 2-methylaminomethyl-1,3-dioxane, and dimethylaminopropyl urea.

The autocatalytic polyols (b2a) are polyols of (b1) type modified with a polyepoxide and an amine based molecule as described above.

The production of polyols (b2a) is based on the reactions of a polyepoxide with a polyol (b1) and an amine based molecule to obtain a tertiary amine function in the final molecule. The three reactants can be mixed together or the polyepoxide can first be pre-reacted partially with one of the two components and then added to the third one. Addition of heat and proper catalysis may be used to control these reactions. It is important to note that these reactions generate hydroxyl groups. Levels of amine and polyepoxide to carry out these reactions are calculated to obtain preferably half of the epoxide to react with at least 10 percent of the polyol and its other half to react with a stoichiometric amount of the amine containing reactive hydrogens.

The autocatalytic polyols (b2b) are polyols of (b1) type modified by the reactions with an epihalohydrin and an amine based molecule to obtain a tertiary amine function in the final molecule. Preferably the halogen is chlorine, bromine or fluorine. Chlorine is the most preferred halogen, that is epichlorohydrin.

The production of polyol (b2b), when the halogen is chlorine, is based on the reaction (end-capping) of a polyol (b1) with epichlorohydrin using an acid catalyst such as boron trifluoride or double metal cyanide (DMC) catalysts. An amine based molecule containing at least one reactive hydrogen able to react with the chlorohydrin group and to get tertiary amine functions is then added and reacted, followed by removal of the resultant amine hydrochloride salt by-products by methods such as distillation or extraction, optionally preceded by treatment with a base such as an alkali metal hydroxide or excess tertiary amine. Optionally, the chlorohydrin segment resulting from end-capping with epichlorohydrin can be treated with a base and eventually a co-catalyst such as a quaternary ammonium compound, to effect ring-closure of the chlorohydrin to an epoxy end-group on the polyol. This will make a compound able to react with an amine to get polyol (b2) of (b2b) type.

The autocatalytic polyols (b2c) are those based on epihalohydrin, preferably epichlorohydrin, as a co-monomer and subsequent reaction with an amine based molecule containing at least one reactive hydrogen able to react with pendant alkylmethyl (chloromethyl) groups and to obtain tertiary amine functions.

The production of polyol (b2c), when the halogen is chlorine, is based upon the steps of a) reaction of epichlorohydrin as a co-monomer along with another alkylene oxide in preparation of a polyol containing various levels of pendant alkylchloride functionality, followed by b) reaction of an amine containing at least one reactive hydrogen, as described above, capable of reacting with the alkylchloride functionality within the epichlorohydrin-oxide copolymer to get tertiary amine functions, followed by c) removal of the resultant amine hydrochloride salt by-products by methods such as distillation or extraction, optionally preceded by treatment with a base such as an alkali metal hydroxide or excess tertiary amine.

The epichlorohydrin-alkylene oxide or polyol copolymers may be prepared using acid catalysts, such as boron trifluoride, or more preferably using double metal cyanide (DMC) catalysts such as those described in many references including U.S. Pat. Nos. 5,158,922; 4,843,054; 4,477,589; 3,427,334; 3,427,335; 3,427,256; 3,278,457; and 3,941,849. Another option is the use of phosphazenium catalyst. The epichlorohydrin can be incorporated at various levels within the polyol depending on the level of autocatalytic effect which is sought for. Indeed the more epichlorohydrin added the more amines can be reacted in the polyol. Incorporation of epichlorohydrin may be performed sequentially, forming block co-polymer structure, or mixture of epichlorohydrin and alkylene oxide(s) can be co-fed, providing random co-polymer structure. Chlorohydrin end-groups and pendant alkylchloride groups can be combined in a single polyol.

The autocatalytic polyols (b2d) are those obtained by grafting of tertiary amine functions via functional azo or peroxide initiators.

The production of polyol (b2d) is based upon reaction of polyol (b1) with a molecule containing at least one tertiary amine functional group and at least one free radical generating functional group. The tertiary amine functional group becomes anchored to the polyol via decomposition of the free radical generating group to free radicals bearing tertiary amine functionality which subsequently react with the polyol. Coupling can occur by direct addition of the free radical to unsaturation present in the polyol or by other radical processes such as radical—radical coupling. The reactions producing (b2d) can be performed prior to utilization of the polyol or at the same time as polyurethane production. In this latter case, proper cautions will be taken, such as use of a separate polyol stream, to avoid unwanted side-reactions with other polyurethane formulation components.

By way of example, a class of azo compounds is represented by the formula X—R³—N═N—R⁴
where R is as previously defined,
X is —N(R¹)₂ or a cyclic heterocyclic ring containing a tertiary amine and R¹ is a previously defined;
R³ is a moiety containing 1 to 12 carbon atoms and optionally other hetero atoms or may be combined with X to form a herterocyclic ring;
R⁴ is a moiety having 1 to 20 carbon atoms or may be attached together with the nitrogen atom and optionally other hetero atoms and alkyl-substituted hetero atoms to form a saturated heterocyclic ring or can be an (—R³—X) moiety. Examples of cyclic structures containing a tertiary amine derived from imidizole, pyrole, pyrimidine and triazines. Examples of commercially available azo compounds containing a tertiary amine are VA-44 and VA-061 available from Wako Chemicals USA.

In a similar manner, a functional peroxide initiator can be presented by X—R³—O—O—R⁴ where X, R³ and R⁴ are as defined above. The R³ and R⁴ moieties for the azo and peroxide intiators may be substituted to contain additional azo or tertiary amine moieties or additional functional groups. Thus the compounds can contain multiple tertiary amine moieties or multiple radical grafting sites, which upon homolytic cleavage of the azo or peroxy group provides at least two separate structures containing a reactive amine and radical sites to provide the grafting. By way of example, a polyperoxy compound based on triazine is represented by 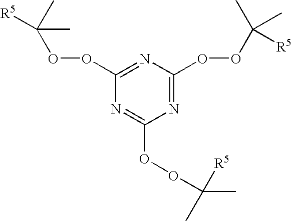
where R⁵ is a moiety containing 1 to 12 carbon atoms. Such peroxy triazines are commercially available from Akzo Chemical Company.

The autocatalytic polyol (b2e) are those obtained by grafting of tertiary amine functions via reactive functionality such as sulfonyl azide. In general the sulfonyl azide compounds can be represented by the general formula X—R³—SO₂N₃ where X and R³ are as previously defined.

The production of polyol (b2e) is based upon reaction of polyol (b1) with a molecule containing at least one tertiary amine functional group and at least one sulfonyl azide functional group. The tertiary amine functional group becomes anchored to the polyol via chemical transformation of the sulfonyl azide functional group. Coupling can occur by direct addition of the sulfonyl azide to unsaturation present in the polyol or by decomposition of the sulfonyl azide to a nitrene with subsequent insertion into the polyol. The coupling to produce (b2e) can be performed prior to utilizing of the polyol or at the same time as polyurethane production. In this latter case, proper cautions will be taken, such as use of a separate polyol stream, to avoid unwanted side-reactions with other polyurethane formulation components.

All of these polyol (b1) modifications can be carried out during or at the end of its manufacturing step. For instance a diepoxide can be reacted with the polyol just after capping it with epichlorohydrin. Epihalohydrin based, for instance, on a fluorine and/or bromine, can be substituted for epichlorohydrin. It is also feasible to prereact the amine, provided it is not a dialykl amine, with the epihalohydrin as taught in U.S. Pat. No. 4,510,269 (Example 1) to obtain a glycidyl amine and subsequently reacting its epoxide group with the polyol (b1). Another option is to react the epoxide with the hydroxyl group of the polyol via an acid anhydride.

The properties of the autocatalytic polyols (b2) can vary widely as described above for polyol (b1) and such parameters as average molecular weight, hydroxyl number, functionality, etc. will generally be selected based on the end use application of the formulation, that is, what type of polyurethane product. Selection of a polyol with the appropriate hydroxyl number, level of ethylene oxide, propylene oxide and butylene oxide, functionality and equivalent weight are standard procedures known to those skilled in the art. For example, polyols with a high level of ethylene oxide will be hydrophilic, while polyols with a high amount of propylene oxide or butylene oxide will be more hydrophobic.

The polyols of (b2) include conditions where the polyol is reacted with a polyisocyanate to form a prepolymer and subsequently polyol is optionally added to such a prepolymer.

Polyester polyols (b2) can be prepared by the reaction of a conventional polyester (b1) with a polyepoxide and a tertiary amine based molecule containing at least one group reactive with epoxides. These can be used in combination with conventional polyester polyols as used today in slabstock or in elastomers, such as shoe soles, or can be combined with polyether polyols.

The limitations described with respect to the characteristics of the polyols (b1) and (b2) above are not intended to be restrictive but are merely illustrative of the large number of possible combinations for the polyol or polyols used.

In a preferred embodiment the polyepoxide of polyol (b2a) is a diepoxide and the amine based molecule containing at least one reactive hydrogen has a methyl-amino or a dimethyl amino or a piperazine, or an amidine or a pyridine or a pyrimidine or a quinuclidine or an adamantane or a triazine or an imidazole structure combined with secondary and/or primary amines and/or secondary and/or primary hydroxyls.

In a preferred embodiment polyols (b2b) and (b2c) are made from amines containing at least one reactive hydrogen which has a methyl-amino or a dimethyl amino or a piperazine or an amidine or a pyridine or a pyrimidine or a quinuclidine or an adamantane or a triazine or an imidazole structure combined with secondary and/or primary amines and/or secondary and/or primary hydroxyls

In a preferred embodiment of polyol (b2e) the compound for modifying polyol (b1) contains a single sulfonyl azide functional group and one or two tertiary amine functional groups. The preferred compound bears tertiary amine group(s) derived from substituted dimethylamine, morpholine, piperazine, piperidine, amidine, pyridine, pyrimidine, quinuclidine, adamantane, triazine or imidazole.

In a preferred embodiment of polyol (b2d) the compound used for modifying polyol (b1) contains a single azo or peroxide functional group and one or two tertiary amine functional groups. The preferred compound bears tertiary amine functional group(s) derived from substituted dimethylamine, morpholine, piperazine, piperidine, amidine, pyridine, pyrimidine, quinuclidine, adamantane, triazine or imidazole.

The weight ratio of (b1) to (b2) will vary depending on the amount of additional catalyst one may desire to add to the reaction mix and to the reaction profile required by the specific application and to eventual use of another autocatalytic polyol of (b3) type in the formulation. Generally if a reaction mixture with a base level of catalyst having specified curing time, (b2) is added in an amount so that the curing time is equivalent where the reaction mix contains at least 10 percent by weight less catalyst. Preferably the addition of (b2) is added to give a reaction mixture containing 20 percent less catalyst than the base level. More preferably the addition of (b2) will reduce the amount of catalyst required by 30 percent over the base level. For some applications, the most preferred level of (b2) addition is where the need for a volatile tertiary or reactive amine catalysts or organometallic salt is eliminated.

Combination of two or more autocatalytic polyols of (b2) type can also be used with satisfactory results in a single polyurethane formulation when one wants for instance to adjust blowing and gelling reactions modifying the two polyol structures with different tertiary amines, functionalities, equivalent weights, EO/PO ratio etc, and their respective amounts in the formulations.

Partial Acid blocking of the polyol (b2) can also be considered when, for instance, delayed action is required. Acids used can be carboxylic acids such as formic or acetic acids, salicylic acid, an amino acid or a non-organic acid such as sulfuric or phosphoric acid.

Polyols pre-reacted with polyisocyanates and polyol (b2) with no free isocyanate functions can also be used in the polyurethane formulation. Isocyanate prepolymers based on polyol (b2) can be prepared with standard equipment, using conventional methods, such a heating the polyol (b2) in a reactor and adding slowly the isocyanate under stirring and then adding eventually a second polyol, or by prereacting a first polyol with a diisocyanate and then adding polyol (b2).

The isocyanates which may be used with the autocatalytic polyols of the present invention include aliphatic, cycloaliphatic, arylaliphatic and aromatic isocyanates. Aromatic isocyanates, especially aromatic polyisocyanates are preferred.

Examples of suitable aromatic isocyanates include the 4,4′-, 2,4′ and 2,2′-isomers of diphenylmethane diisocyante (MDI), blends thereof and polymeric and monomeric MDI blends toluene-2,4- and 2,6-diisocyanates (TDI), m- and p-phenylenediisocyanate, chlorophenylene-2,4-diisocyanate, diphenylene-4,4′-diisocyanate, 4,4′-diisocyanate-3,3′-dimehtyldiphenyl, 3-methyldiphenyl-methane-4,4′-diisocyanate and diphenyletherdiisocyanate and 2,4,6-triisocyanatotoluene and 2,4,4′-triisocyanatodiphenylether.

Mixtures of isocyanates may be used, such as the commercially available mixtures of 2,4- and 2,6-isomers of toluene diisocyantes. A crude polyisocyanate may also be used in the practice of this invention, such as crude toluene diisocyanate obtained by the phosgenation of a mixture of toluene diamine or the crude diphenylmethane diisocyanate obtained by the phosgenation of crude methylene diphenylamine. TDI/MDI blends may also be used. MDI or TDI based prepolymers can also be used, made either with polyol (b1), polyol (b2) or any other polyol as described heretofore. Isocyanate-terminated prepolymers are prepared by reacting an excess of polyisocyanate with polyols, including aminated polyols or imines/enamines thereof, or polyamines.

Examples of aliphatic polyisocyanates include ethylene diisocyanate, 1,6-hexamethylene diisocyanate, isophorone diisocyanate, cyclohexane 1,4-diisocyanate, 4,4′-dicyclohexylmethane diisocyanate, saturated analogues of the above mentioned aromatic isocyanates and mixtures thereof.

The preferred polyisocyantes for the production of rigid or semi-rigid foams are polymethylene polyphenylene isocyanates, the 2,2′, 2,4′ and 4,4′ isomers of diphenylmethylene diisocyanate and mixtures thereof. For the production of flexible foams, the preferred polyisocyanates are the toluene-2,4- and 2,6-diisocyanates or MDI or combinations of TDI/MDI or prepolymers made therefrom.

Isocyanate tipped prepolymer based on polyol (b2) can also be used in the polyurethane formulation. It is thought that using such an autocatalytic polyol in a polyol isocyanate reaction mixture will reduce/eliminate the presence of unreacted isocyanate monomers. This is especially of interest with volatile isocyanates such as TDI and/or aliphatic isocyanates in coating and adhesive applications since it improves handling conditions and workers safety.

For rigid foam, the organic polyisocyanates and the isocyanate reactive compounds are reacted in such amounts that the isocyanate index, defined as the number or equivalents of NCO groups divided by the total number of isocyanate reactive hydrogen atom equivalents multiplied by 100, ranges from 80 to less than 500 preferably from 90 to 100 in the case of polyurethane foams, and from 100 to 300 in the case of combination polyurethane-polyisocyanurate foams. For flexible foams, this isocyanate index is generally between 50 and 120 and preferably between 75 and 110.

For elastomers, coating and adhesives the isocyanate index is generally between 80 and 125, preferably between 100 to 110.

For producing a polyurethane-based foam, a blowing agent is generally required. In the production of flexible polyurethane foams, water is preferred as a blowing agent. The amount of water is preferably in the range of from 0.5 to 10 parts by weight, more preferably from 2 to 7 parts by weight based on 100 parts by weight of the polyol. Carboxylic acids or salts are also used as reactive blowing agents.

In the production of rigid polyurethane foams, the blowing agent includes water, and mixtures of water with a hydrocarbon, or a fully or partially halogenated aliphatic hydrocarbon. The amount of water is preferably in the range of from 2 to 15 parts by weight, more preferably from 2 to 10 parts by weight based on 100 parts of the polyol. With excessive amount of water, the curing rate becomes lower, the blowing process range becomes narrower, the foam density becomes lower, or the moldability becomes worse. The amount of hydrocarbon, the hydrochlorofluorocarbon, or the hydrofluorocarbon to be combined with the water is suitably selected depending on the desired density of the foam, and is preferably not more than 40 parts by weight, more preferably not more than 30 parts by weight based on 100 parts by weight of the polyol. When water is present as an additional blowing agent, it is generally present in an amount from 0.5 to 10, preferably from 0.8 to 6 and more preferably from 1 to 4 and most preferably from l to 3 parts by total weight of the total polyol composition.

Hydrocarbon blowing agents are volatile C₁ to C₅ hydrocarbons. The use of hydrocarbons is known in the art as disclosed in EP 421 269 and EP 695 322. Preferred hydrocarbon blowing agents are butane and isomers thereof, pentane and isomers thereof (including cyclopentane), and combinations thereof.

Examples of fluorocarbons include methyl fluoride, perfluoromethane, ethyl fluoride, 1,1-difluoroethane, 1,1,1-trifluoroethane (HFC-143a), 1,1,1,2-tetrafluoroethane (HFC-134a), pentafluoroethane, difluoromethane, perfluoroethane, 2,2-difluoropropane, 1,1,1-trifluoropropane, perfluoropropane, dichloropropane, difluoropropane, perfluorobutane, perfluorocyclobutane.

Partially halogenated chlorocarbons and chlorofluorocarbons for use in this invention include methyl chloride, methylene chloride, ethyl chloride, 1,1,1-trichloroethane, 1,1-dichloro-1-fluoroethane (FCFC-141b), 1-chloro-1,1-difluoroethane (HCFC-142b), 1,1-dichloro-2,2,2-trifluoroethane (HCHC-123) and 1-chloro-1,2,2,2-tetrafluoroethane (HCFC-124).

Fully halogenated chlorofluorocarbons include trichloromonofluoromethane (CFC-11) dichlorodifluoromethane (CFC-12), trichlorotrifluoroethane (CFC-113), 1,1,1-trifluoroethane, pentafluoroethane, dichlorotetrafluoroethane (CFC-114), chloroheptafluoropropane, and dichlorohexafluoropropane. The halocarbon blowing agents may be used in conjunction with low-boiling hydrocarbons such as butane, pentane (including the isomers thereof), hexane, or cyclohexane or with water.

Use of carbon dioxide, either as a gas or as a liquid, as auxiliary or full blowing agent is especially of interest with the present technology. Reduced or increased atmospheric pressure as well as use of DMC (dimethylcarbonate) is also possible with the present technology.

In addition to the foregoing critical components, it is often desirable to employ certain other ingredients in preparing polyurethane polymers. Among these additional ingredients are surfactants, preservatives, flame retardants, colorants, antioxidants, reinforcing agents, stabilizers and fillers.

In making polyurethane foam, it is generally preferred to employ an amount of a surfactant to stabilize the foaming reaction mixture until it cures. Such surfactants advantageously comprise a liquid or solid organosilicone surfactant. Other surfactants include polyethylene glycol ethers of long-chain alcohols, tertiary amine or alkanolamine salts of long-chain alkyl acid sulfate esters, alkyl sulfonic esters and alkyl arylsulfonic acids. Such surfactants are employed in amounts sufficient to stabilize the foaming reaction mixture against collapse and the formation of large, uneven cells. Typically, 0.2 to 3 parts of the surfactant per 100 parts by weight total polyol (b) are sufficient for this purpose.

One or more catalysts for the reaction of the polyol (and water, if present) with the polyisocyanate can be used. Any suitable urethane catalyst may be used, including tertiary amine compounds, amines with isocyanate reactive groups and organometallic compounds. Preferably the reaction is carried out in the absence of an amine or an organometallic catalyst or a reduced amount as described above. Exemplary tertiary amine compounds include triethylenediamine, N-methylmorpholine, N,N-dimethylcyclohexylamine, pentamethyldiethylenetriamine, tetramethylethylenediamine, bis (dimethylaminoethyl)ether, 1-methyl-4-dimethylaminoethyl-piperazine, 3-methoxy-N-dimethylpropylamine, N-ethylmorpholine, dimethylethanolamine, N-cocomorpholine, N,N-dimethyl-N′,N′-dimethyl isopropylpropylenediamine, N,N-diethyl-3-diethylamino-propylamine and dimethylbenzylamine. Exemplary organometallic catalysts include organomercury, organolead, organoferric and organotin catalysts, with organotin catalysts being preferred among these. Suitable tin catalysts include stannous chloride, tin salts of carboxylic acids such as dibutyltin di-laurate, as well as other organometallic compounds such as are disclosed in U.S. Pat. No. 2,846,408 or in EP 1,013,704; EP 1,167,410 or EP 1,167,411. A catalyst for the trimerization of polyisocyanates, resulting in a polyisocyanurate, such as an alkali metal alkoxide may also optionally be employed herein. The amount of amine catalysts can vary from 0.02 to 5 percent in the formulation or organometallic catalysts from 0.001 to 1 percent in the formulation can be used.

A crosslinking agent or a chain extender may be added, if necessary. The crosslinking agent or the chain extender includes low-molecular polyhydric alcohols such as ethylene glycol, diethylene glycol, 1,4-butanediol, and glycerin; low-molecular amine polyol such as diethanolamine and triethanolamine; polyamines such as ethylene diamine, xlylenediamine, and methylene-bis(o-chloroaniline). The use of such crosslinking agents or chain extenders is known in the art as disclosed in U.S. Pat. Nos. 4,863,979 and 4,963,399 and EP 549,120.

When preparing rigid foams for use in construction, a flame retardant is generally included as an additive. Any known liquid or solid flame retardant can be used with the autocatalytic polyols of the present invention. Generally such flame retardant agents are halogen-substituted phosphates and inorganic flame proofing agents. Common halogen-substituted phosphates are tricresyl phosphate, tris(1,3-dichloropropyl phosphate, tris(2,3-dibromopropyl) phosphate and tetrakis (2-chloroethyl)ethylene diphosphate. Inorganic flame retardants include red phosphorous, aluminum oxide hydrate, antimony trioxide, ammonium sulfate, expandable graphite, urea or melamine cyanurate or mixtures of at least two flame retardants. In general, when present, flame retardants are added at a level of from 5 to 50 parts by weight, preferable from 5 to 25 parts by weight of the flame retardant per 100 parts per weight of the total polyol present.

The applications for foams produced by the present invention are those known in the industry. For example rigid foams are used in the construction industry and for insulation for appliances and refrigerators. Flexible foams and elastomers find use in applications such as furniture, shoe soles, automobile seats, sun visors, steering wheels, armrests, door panels, noise insulation parts and dashboards.

Processing for producing polyurethane products are well known in the art. In general components of the polyurethane-forming reaction mixture may be mixed together in any convenient manner, for example by using any of the mixing equipment described in the prior art for the purpose such as described in “Polyurethane Handbook”, by G. Oertel, Hanser publisher.

The polyurethane products are either produced continuously or discontinuously, by injection, pouring, spraying, casting, calendering, etc; these are made under free rise or molded conditions, with or without release agents, in-mold coating, or any inserts or skin put in the mold. In case of flexible foams, those can be mono- or dual-hardness.

For producing rigid foams, the known one-shot prepolymer or semi-prepolymer techniques may be used together with conventional mixing methods including impingement mixing. The rigid foam may also be produced in the form of slabstock, moldings, cavity filling, sprayed foam, frothed foam or laminates with other material such as paper, metal, plastics or wood-board. Flexible foams are either free rise and molded while microcellular elastomers are usually molded.

The following examples are given to illustrate the invention and should not be interpreted as limiting in anyway. Unless stated otherwise, all parts and percentages are given by weight.

A description of the raw materials used in the examples is as follows.

| | |
|---|---|
| DEOA 85 percent | is 85 percent pure diethanolamine |
| and | 15 percent water. |
| DMAPA | is 3-dimethylamino-1-propylamine. |
| 2-Methylimidazole | is a tertiary amine with a reactive |
| | hydrogen available from Aldrich. |
| D.E.R.* 736 P | is an aliphatic diepoxide resin with |
| | an EEW (epoxy equivalent weight) |
| | of 190 available from The Dow |
| | Chemical Company. |
| Dabco DC 5169 | is a silicone-based surfactant |
| | available from Air Products and |
| | Chemicals Inc. |
| Dabco 33 LV | is a tertiary amine catalyst |
| | available from Air Products and |
| | Chemicals Inc. |
| Niax A-1 | is a tertiary amine catalyst |
| | available from Crompton Corporation. |
| Polyol A | is a tertiary amine modified polyol |
| | made by reaction between Specflex NC |
| | 632, D.E.R. 736P and DMAPA. |
| Polyol B | is a tertiary amine modified polyol |
| | made by reaction between Specflex NC |
| | 632, D.E.R. 736P and 2-methylimidazole. |
| Polyol C | is a 1,700 equivalent weight |
| | propoxylated tetrol initiated with |
| | 3,3′-diamino-N-methyl dipropylamine |
| | and capped with 15 percent Ethylene oxide. |
| SPECFLEX NC 632 | is a 1,700 EW polyoxypropylene |
| | polyoxyethylene polyol initiated |
| | with a blend of glycerol and |
| | sorbitol available from The Dow |
| | Chemical Company. |
| SPECFLEX NC-700 | is a 40 percent SAN based copolymer |
| | polyol with an average hydroxyl |
| | number of 20 available from The Dow |
| | Chemical Company. |
| VORANATE T-80 | is TDI 80/20 isocyanate available |
| | from The Dow Chemical Company. |

All foams were made in the laboratory by preblending polyols, surfactants, crosslinkers, catalysts and water and the isocyanate was then added under stirring at 3,000 RPM. After mixing for 5 seconds, the mixture is poured in a 30×30×10 cm aluminum mold heated at 60° C. which is subsequently closed. The mold had previously been sprayed with the release agent Klueber 41-2013 available from Klueber Chemie. Curing at a specific demolding times is assessed by manually demolding the part and looking for defects. The minimum demolding time is reached where there is no surface defects.
BVT (Brookfield Viscosity) tests are carried out as follows: 100 grams of polyol are allowed to equilibrate at 25° C. and then blended with 0.26 grams of Dabco 33 LV. Voranate T-80 is then added at a concentration corresponding to an index of 110. The viscosity build up over time is recorded until full gelation is obtained. In the case of autocatalytic polyols, these are either used by themselves or blended at various ratios with the control polyol. In all cases no catalysts are added. When total gelation is not obtained 650 seconds after adding Voranate T-80 the percentage of torque vs the final aimed viscosity of 20,000 mpa·s (corresponding to 100 percent torque) is recorded.

### EXAMPLE 1

Production of Tertiary Amine Modified Polyol A:

Specflex NC-632 (880 grams) and D.E.R. 736 P (100 grams) were charged in a 3-neck 1 liter glass reactor equipped with mechanical stirrer, thermocouple and nitrogen inlet, and heated to 110° C. Methyltrifluoromethanesulfonate (0.175 grams) was added to the mixture. This reaction mixture was kept at 110° C. for 20 minutes and then heated at 125° C. for 45 minutes. At this stage a sample was taken and found to contain 1.25 percent epoxides, indicating about 50 percent of the original epoxide was unreacted. The reaction mixture temperature was reduced to 110° C. and DMAPA (20 grams) was slowly added over 10 minutes. This mixture was then kept at 110° C. for another 95 minutes. The resin was then cooled and poured in a bottle. This sample was liquid at room temperature and was found to contain no free epoxy groups and no free DMAPA. An analysis of this product confirmed that this polyol contained 48 percent of tertiary-epoxy modified polyol (b2a) and 52 percent of unreacted Specflex NC-632.

### EXAMPLE 2

Production of Tertiary Amine Modified Polyol B:

The same procedure of Example 1 was used with 2-methylimidazole used in place of DMAPA. The composition of polyol is:

| | | |
|---|---|---|
| D.E.R. 736 P | 9.979 | percent |
| Specflex NC 632 | 87.93 | percent |
| 2-Methylimidazole | 2.09 | percent |
| Methyl trifluoromethanesulfonate | 175 | ppm |

Polyol B has a viscosity at 25° C. of about 15,000 mpa·s.

### EXAMPLE 3

A polyurethane foam is produced with the following formulations containing 20 PHP (parts per hundred parts of polyol) Polyol A of Example 1 (or 0.4 active DMAPA) and no gelation catalyst, Dabco 33LV. Demolding time was 4 minutes. Foam curing was considered acceptable.

| | |
|---|---|
| Specflex NC 632 | 50 |
| Specflex NC 700 | 30 |
| Polyol A example 1 | 20 |
| Niax A-1 | 0.10 |
| Dabco DC 5169 | 0.60 |
| DEOA (85 percent) | 0.80 |
| Water | 3.50 |
| Voranate T-80 | 41.3 |
| Mold exit time (s) | 47 |
| Molded density (kg/m3) | 34.8 |

Foam properties measured according to VW-AUDI and ASTM test methods are:

| | | |
|---|---|---|
| 40 percent CFD | 3.8 | Kpa (compression Force Deflection) |
| Airflow | 4.6 | cfm (cubic foot/minute of air) |
| 50 percent | 9.9 | percent |
| Compression set (CT) | | |
| Resiliency | 64 | percent |
| Tear Strength | 164 | N/m |
| Tensile Strength | 82 | Kpa |
| Elongation at break | 94 | percent |

### EXAMPLES 3 to 6

Comparative BVT tests based on Specflex NC-632 as the control polyol confirm that Polyol A of Example 1 and Polyol B of Example 2 give results comparable to Dabco 33 LV in terms of gelation profile.

| | Product tested | percent torque/time (s) |
|---|---|---|
| Example 3 | Polyol A example 1 | 25 percent at 650 s |
| | at 10 PHP in NC-632 | |
| Example 4 | Polyol A example 1 | 100 percent at 630 s |
| | at 15 PHP in NC 632 | |
| Example 5 | Polyol A example 1 | 100 percent at 90 s |
| | at 20 PHP in NC 632 | |
| Example 6 | Polyol B example 2 | 100 percent at 270 s |
| | At 10 PHP in NC 632 | |
| Comparative | 100 PHP NC 632 and | 100 percent at 340 s |
| example A* | 0.26 parts Dabco 33LV | |
| Comparative | 100 PHP NC 632 and | 38 percent at 650 s |
| example B* | 0.3 parts DMAPA | |
| Comparative | 100 PHP NC 632 and | 100 percent at 510 s |
| example C* | 0.4 parts DMAPA | |

*Comparative examples, not part of this invention

These data confirm that 20 PHP polyol A of Example 1 (or 0.4 PHP DMAPA) gives a faster gelation than 0.26 PHP Dabco 33 LV or 0.4 PHP DMAPA and that Polyol B based on 2-methylimidazole is stronger (gelling faster at same level of amine) than Polyol A based on an amine containing a dimethylamino group.

### EXAMPLES 7 and 8

Comparative foaming tests were carried with polyol B by itself or combined with Polyol C based on the teaching of WO 01/58,976 using either reduced amounts of amine catalysts or no amine catalysts. In all cases foam processing was found to be acceptable.

| | Example | | |
|---|---|---|---|
| | D* | 7 | 8 |
| Specflex NC632 | 70 | 50 | 0 |
| Specflex NC700 | 30 | 30 | 30 |
| Polyol B | 0 | 20 | 20 |
| Polyol C | 0 | 0 | 50 |
| Niax A1 | 0.05 | 0.05 | 0 |
| Dabco 33LV | 0.40 | 0 | 0 |
| DEOA 85 percent | 0.80 | 0.80 | 0.80 |
| Dabco DC 5169 | 0.60 | 0.60 | 0.60 |
| Water | 3.5 | 3.5 | 3.5 |
| Voranate T-80 Index | 100 | 100 | 100 |
| Mold exit time (s) | 42 | 48 | 38 |
| Demolding time (s) | 240 | 240 | 240 |
| Part weight (g) | 321 | 323 | 323 |
| Molded density (kg/m3) | 35.7 | 35.9 | 35.9 |

*example D* not part of this invention

Example 7 demonstrates that 0.4 PHP Dabco 33 LV can be replaced by 20 PHP of polyol B. Example 8 shows that total elimination of amine catalysts is obtained by combining Polyol B, object of the invention, with another type of autocatalytic polyol, polyol C made from an amine initiator showing good blowing efficiency and replacing the blowing catalyst, Niax Al.

Other embodiments of the invention will be apparent to those skilled in the art from a consideration of this specification or practice of the invention disclosed herein. It is intended that the specification and examples be considered as exemplary only, with the true scope and spirit of the invention being indicated by the following claims.

1. A process for the production of a polyurethane product by reaction of a mixture of
(a) at least one organic polyisocyanate with
(b) a polyol composition comprising
(b1) from 0 to 99 percent by weight of a polyol compound having a functionality of 2 to 8 and a hydroxyl number of from 20 to 800 and
(b2) from 1 to 100 percent by weight of at least one polyol compound having a functionality of 1 to 12, a hydroxyl number of from 20 to 800 and containing at least one tertiary amine group,
wherein the weight percent is based on the total amount of polyol composition (b), (b1) is different than (b2) and (b2) is one or more of:
polyol (b2a) obtained by the reactions of a polyol of (b 1) type with a polyepoxide and an amine based molecule wherein the amine-base molecule is a secondary amine or a molecule containing at least one tertiary nitrogen and at least one reactive hydrogen able to react with the epoxide group;
polyol (b2b) obtained by the reactions of a polyol of (b1) type with an epihalohydrin and an amine based molecule wherein the amine based molecule is a secondary amine or a molecule containing at least one tertiary nitrogen and at least one reactive hydrogen able to react with the product of the polyol (b1) an epihalohydrin group;
or polyol (b2c) obtained by reaction of a polyol made from epihalohydrin as a co-monomer together with propylene oxide and/or ethylene oxide and an amine based molecule wherein the amine based molecule is a secondary amine or a molecule containing at least one tertiary nitrogen and at least one reactive hydrogen able to react with a haloalkyl;
or polyol (b2d) obtained by grafting of tertiary amine functions to a conventional polyol of (b1) type by functional azo and/or peroxide initiator;
or polyol (b2e) obtained by grafting of tertiary amine functions onto a polyol of (b1) type via reactive functionality such as sulfonyl azide;
or (b2) is (b2f) a hydroxyl-tipped prepolymer obtained from the reaction of an excess of (b2a)-(b2e) or a mixture thereof with a polyisocyanate;
or (b2) is (b2g) a blend of several polyols (b1) modified with one or more polyepoxides and/or polyol (b2) blended with one or more types of amine initiated polyols containing each at least one reactive hydrogen or a blend of (b2a) and/or (b2b) and/or (b2c) and/or (b2d) and/or (b2e);
(c) optionally in the presence of a blowing agent; and
(d) optionally additives or auxiliary agents known per se for the production of polyurethane foams, elastomers and/or coatings.

2. The process of claim 1 wherein polyol (b1) comprises a polyether polyol, polyester polyol, polyhydroxy-terminated acetal resin, hydroxyl-terminated amine polyol, hydroxyl-terminated polyamine polyol or a mixture thereof.

3. The process of claim 1 wherein polyol (b1) comprises a polyester polyol, a polyether polyol or a mixture thereof.

4. The process of claim 1 wherein the secondary amine used for obtaining a polyol of (b2a), (b2b) or (b2c) is represented by HNR¹₂ where each R¹ is independently a compound having 1 to 20 carbon atoms or may be attached together with the nitrogen atom and optionally other hetero atoms and alkyl-substituted hetero atoms to form one or two saturated heterocyclic or aromatic ring(s).

5. The process of claim 1 wherein the tertiary amine used for obtaining a polyol of (b2a), b2b) or (b2c) is represented by (R³)ₓ-A-(R²-M)_{z}-(R²)_{y}
where A is either hydrogen, nitrogen or oxygen;
x is 0, 1 or2;
z is 1 or 2
with the provisos x is zero when A is hydrogen, x and z are 1 when A is oxygen, and
when A is nitrogen x and z can be 1 or 2 with the sum of x and z being 3;
R² at each occurrence is independently a moiety having 1 to 20 carbon atoms;
R³ is hydrogen or a moiety having 1 to 20 carbon atoms;
M is an amine or polyamine, linear, branched or cyclic, with at least one tertiary amine group; and
y is an integer from 0 to 6.

6. The process of claim 1 wherein the secondary or tertiary amine used for the production of polyol (b2a), (b2b) or (b2c) is one or more amines selected from the group consisting of dimethylamine, diethylamine, N,N-dimethylethanolamine, N,N-dimethyl-N′-ethylenediamine, 3-dimethylamino-1-propanol, 1-dimethylamino-2-propanol, 3-(dimethylamino) propylamine, dicyclohexylamine, 1-(3-aminopropyl)-imidazole, 3-hydroxymethyl quinuclidine, imidazole, 2-methyl imidazole, 1-(2-aminoethyl)-piperazine, 1-methyl-piperazine, 3-quinuclidinol, tetramethylamino-bis-propylamine, 2-(2-aminoethoxy)-ethanol, N,N-dimethylaminoethyl-N′-methyl ethanolamine and 2-(methylamino)-ethanol.

7. The process of claim 1 wherein the secondary or tertiary amine used for the production of polyol (b2a), (b2b) or (b2c) is one or more amines selected from the group consisting of N,N′-dimethylethylenediamine, 4,6-dihydroxypyrimidine, 2,4-diamino-6-hydroxypyrimidine, 2,4-diamino-6-methyl-1,3,5-triazine, 3-aminopyridine, 2,4-diaminopyrimidine, 2-phenyl-imino-3-(2-hydroxyethyl)-oxazalodine,N-(-2-hydroxyethyl)-2-methyl-tetrahydropyrimidine, N-(2-hydroxyethyl)-imidazoline,2,4-bis-(N-methyl-2-hydroxytethylamino)-6-phenyl-1,3,5-triazine, bis-(dimethylaminopropyl)amino-2-propanol, 2-(2-methylaminoethyl)-pyridine, 2-(methylamino)-pyridine, 2-methylaminomethyl-1,3-dioxane and dimethylaminopropyl urea.

8. The process of claim 1 wherein the epoxy resin for the production of polyol (b2a) or (b2b) is represented by the general formula general formula: 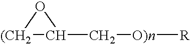
wherein R is substituted or unsubstituted aromatic, alphatic, cycloaliphatic or heterocyclic polyvalent group and n had an average value of from 2 to less than 8.

9. The process of claim 1 wherein the epoxy resin for the production of polyol (b2a), or (b2b) or is selected from one or more of the group consisting diglycidyl ethers of resorcinol, catechol, hydroquinone, bisphenol, bisphenol A, bisphenol AP (1,1-bis(4-hydroxylphenyl)-1-phenyl ethane), bisphenol F, bisphenol K, tetrabromobisphenol A, phenol-formaldehyde novolac resins, alkyl substituted phenol-formaldehyde resins, phenol-hydroxybenzaldehyde resins, cresol-hydroxybenzaldehyde resins, dicyclopentadiene-phenol resins, trimethylolpropane triglycidyl ether, dicyclopentadiene-substituted phenol resins tetramethylbiphenol, tetramethyl-tetrabromobiphenol, tetramethyltribromobiphenol, and tetrachlorobisphenol A and aliphatic diepxoids.

10. The process of claim 9 wherein the epoxy resin for the production of polyol (b2a), or (b2b) is an aliphatic diepoxide.

11. The process of claim 1 wherein the polyol (b2) is produced from the reaction of a polyol of type (b1) with a compound which contains a single azo group or peroxide group and one or two tertiary amine functional groups.

12. The process of claims 11 wherein the tertiary amine is derived from substituted dimethylamine, morpholine, piperazine, piperidine, amidine, pyridine, pyrimidine, quinclidine, admantane, triazine or imidazole.

13. The process of claim 1 wherein the polyol (b2e) is produced from the reaction of a polyol of type (b1) with a single sulfonyl azide functional moiety and one or two tertiary amine functional groups.

14. The process of claim 11 wherein the tertiary amine is derived from one or more of dimethylamine, morpholine, piperazine, piperidine, amidine, pyridine, pyrimidine, quinuclidine, adamantane, triazine or imidazole.

15. The process of claim 1 wherein the polyurethane product is a rigid foam and the polyol (b1) and (b2) have an average functionality of 3 to 6 and an average hydroxyl number of 200 to 800.

16. The process of claim 15 wherein the blowing agent for producing the rigid foam is a hydrocarbon, a hydrochlorofluorocarbon, a hydrofluorocarbon, a hydrochlorocarbon or a mixture thereof.

17. A rigid foam produced by the process of claim 16.

18. The process of claim 1 wherein the polyurethane product is a flexible foam and the polyol (b1) and (b2) have an average functionality of 2 to 4 and an average hydroxyl number of 20 to 100.

19. A flexible foam produced by the process of claim 18.
